(19) United States
(12) Patent Application Publication
(10) Pub. No.: US 2023/0001680 A1
(43) Pub. Date: Jan. 5, 2023

(54) THERMOPLASTIC FILM AND THE MANUFACTURING METHOD THEREOF

(71) Applicant: SAN FANG CHEMICAL INDUSTRY CO., LTD., KAOHSIUNG (TW)

(72) Inventors: CHIH-YI LIN, KAOHSIUNG (TW); KUO-KUANG CHENG, KAOHSIUNG (TW); CHI-CHIN CHIANG, KAOHSIUNG (TW); WEN-HSIN TAI, KAOHSIUNG (TW)

(21) Appl. No.: 17/655,969

(22) Filed: Mar. 22, 2022

(30) Foreign Application Priority Data
Jul. 1, 2021 (TW) 110124211

(51) Int. Cl. B32B 27/40; C08G 18/06; B32B 27/08; B32B 7/027; B29C 48/21; B29C 48/08; B29C 48/88

(52) U.S. Cl. CPC B32B 27/40; C08G 18/06; B32B 27/08; B32B 7/027; B29C 48/21; B29C 48/08; B29C 48/914; B32B 2307/31; B32B 2307/732; B32B 2274/00; B32B 2250/24; B32B 2307/536; B29K 2075/00

(57) ABSTRACT

A thermoplastic film composed of a single-layer of thermally fuse film. The single-layer of thermally fuse film has a melting point of 50° C.-160° C. and a Shore hardness ranges from 40 A-80 A. The present invention also provides another thermoplastic film, which has a multi-layer structure and the multi-layer structure from bottom to top, there are first thermally fuse film, second thermal fuse and third thermally fuse film. The thickness ratio of the first thermally fuse film, the second thermally fuse film and the third thermally fuse film is 1:1-2:1, in which the thermally fuse film, the first thermally fuse film, the second thermally fuse film, and the third thermally fuse film are thermoplastic polyurethane respectively, and thermoplastic polyurethane contains aromatic functional group or with aliphatic functional group.

### CROSS-REFERENCE TO RELATED APPLICATIONS

This application claims the benefit of TW 110124211, filed on Jul. 1, 2021, which is incorporated in its entirety by reference herein.

### FIELD OF THE INVENTION

The present invention relates to the technical field of thermoplastic film, especially relates to improve peel strength and chemical resistance by changing the structure of a thermoplastic film and its manufacturing method thereof.

### BACKGROUND OF THE INVENTION

Elastic adhesive films are often used on clothing and luggage. These elastic adhesive films can enhance the elasticity of fabrics. Some elastic adhesive films have thermally fuse properties and can glue fabrics to other fabrics, thereby reduce the amount of stitching required and become easy to process.

The existing elastic adhesive films are usually thermoplastic polyurethane (TPU) thermally fuse films. These elastic adhesive films are usually impermeable, even though individual films have microporous for air permeability, microporous of the elastic adhesive films are often blocked and the air permeability will be lost, which affects the air permeability of corresponding clothing and luggage. Especially for elastic underwear, which is widely used in elastic film, it will affect the comfort of the wearer. The higher the thermally fuse temperature, the more severe of blockage, and if the thermally fuse temperature is too low, the adhesion between the elastic adhesive film and the fabric will be affected.

The traditional needle and thread stitching technology is used in the garment industry. From appearance, the clothes have stitch marks, which will affect the comfort of the wearer. Currently on the market, most of the thermally fuse adhesive films for garments do not particularly emphasize on chemical resistance. If they are to be used on under garment, user's use of skin care products needs to be taken into consideration to avoid that the ingredients of skin care products will affect the chemical resistance and reduce the peel strength.

### SUMMARY OF THE INVENTION

According to the disadvantages of the prior art, the main object of the present invention is to provide a thermoplastic film, by changing the structure of the thermoplastic film, the outer layer of the thermoplastic film is resistance to chemical immersion, and the inner layer of thermoplastic film may be laminated to the fabric to increase the peel strength of the thermoplastic film.

According to the above objects, the present invention provides a method for manufacturing a thermoplastic film, which includes: providing a first thermally fuse adhesive, a second thermally fuse adhesive, and a third thermally fuse adhesive, in which the melting point and Shore hardness of the two thermally fuse adhesive are different from those of the other; a co-extrusion step is performed to form a multi-layer thermoplastic structure, in which the co-extrusion step includes: a first co-extrusion step is performed with a first extruder to the first thermally fuse adhesive to form a first thermally fuse film, a second co-extrusion step is performed with a second extruder to the second thermally fuse adhesive to form a second thermally fuse film, and a third co-extrusion step is performed with a third extruder to the third thermally fuse adhesive to form a third thermally fuse film, in which the first thermally fuse film, the second thermally fuse film and the third thermally fuse film forms a multi-layer thermoplastic structure, the middle layer of the multi-layer thermoplastic structure is second thermally fuse film, and the top layer and bottom layer of the multi-layer thermoplastic structure are the first thermally fuse film and the third thermally fuse film, and a thickness ratio of the top layer, the middle layer, and bottom layer of the multi-layer thermoplastic structure is 1:1-2:1, and a film forming step is performed, a forming roller is performed to cool the multi-layer thermoplastic structure into a film, and an operation speed of the forming roller is controlled to obtain the multi-layer thermoplastic film with a desired thickness.

In a preferred embodiment of the present invention, a drying step is further performed before the co-extrusion step, in which the drying step includes: the first thermally fuse adhesive, the second thermally fuse adhesive and the third thermally fuse adhesive are dried at a drying temperature ranges from 40° C. to 70° C., thereby, the moisture content of the first thermally fuse adhesive, the second thermally fuse adhesive, and the third thermally fuse adhesive are less than 300 ppm respectively.

In a preferred embodiment of the present invention, the first extruder, the second extruder and the third extruder respectively includes a plurality of temperature zones, the temperature zones of the first extruder and the third extruder includes at least three temperature sections, and the temperature sections are 175° C., 205° C. and 200° C. in sequence, and the plurality temperature zones of the second extruder includes at least three temperature sections, and the temperature sections are 155° C., 175° C. and 170° C. in sequence, and the temperature of the T-Die of the first extruder, the second extruder and the third extruder ranges from 180° C.-190° C.

According to the above, the present invention also provides another method for manufacturing a thermoplastic film, which includes: a thermally fuse adhesive with a melting point ranges from 50° C. to 160° C. and a Shore hardness ranges from 40 A to 80 A is provided, a co-extrusion step is performed with an extruder to the thermally fuse adhesive to form a single-layer thermally fuse film, and a film-forming step is performed, whereby the single-layer thermally fuse film is cooled to form a film by using a forming roller and an operation speed of the forming roller is controlled to obtain a single-layer thermoplastic film with the desired thickness.

In a preferred embodiment of the present invention, a drying step is further performed before performing the co-extrusion step, in which the drying step includes: drying the thermally fuse adhesive at a drying temperature ranges from 40° C. to 70° C., so a moisture content of the thermally fuse adhesive is less than 300 ppm.

In a preferred embodiment of the present invention, the extruder includes a plurality of temperature zones, and the temperature zones of the extruder includes at least three temperature sections, the temperature sections are 175° C., 205° C. and 200° C. in sequence, and the temperature of the T-Die of the extruder ranges from 180° C.-190° C.

According to the manufacturing method as abovementioned, the present invention also provides a thermoplastic film, which is a single-layer thermally fuse film, a melting point of the single-layer thermally fuse film ranges from 50° C. to 160° C. and a Shore hardness ranges from 40 A to 80 A, in which the thermally fuse film is thermoplastic polyurethane (TPU), and the thermoplastic polyurethane may be a thermoplastic polyurethane with aromatic functional groups or with aliphatic functional groups.

According to process steps as abovementioned, the present invention also provides a thermoplastic film, which is a multi-layer structure, includes a first thermally fuse film, a second thermally fuse film, and a third thermally fuse film from bottom to top. The thickness ratio of the first thermally fuse film, the second thermally fuse film, and the third thermally fuse film ranges from 1:11:2, in which the first thermally fuse film, the second thermally fuse film, and the third thermally fuse film are thermoplastic polyurethane, the thermoplastic polyurethane may be thermoplastic polyurethane (TPU) with aromatic functional groups or aliphatic functional groups.

In a preferred embodiment of the present invention, the melting point of the first thermally fuse film and the third thermally fuse film ranges from 50° C. to 120° C., and a Shore hardness of 60 A to 80 A, the melting point of the second thermally fuse film ranges from 90° C. to 160° C., and a Shore hardness of 40 A to 60 A.

In a preferred embodiment of the present invention, the thickness of the first thermally fuse film and the third thermally fuse film accounts for 40%-100% of a total thickness of the thermoplastic film, and a thickness of the second thermally fuse film accounts for 0%-60% of a total thickness of the thermoplastic film.

### BRIEF DESCRIPTION OF THE DRAWINGS

FIG. 1 is a schematic view of showing flow chart of the process steps of multi-layer thermoplastic film in accordance with the present invention disclosed herein.

FIG. 2 is a schematic cross-sectional view of a multi-layer thermoplastic film formed according to the flow chart of FIG. 1.

FIG. 3 is a schematic view of showing the flow chart of process steps of a single-layer thermoplastic film in accordance with the present invention disclosed herein.

FIG. 4 is a schematic cross-sectional view of a single-layer thermoplastic film formed according to the flow chart of FIG. 3.

### DETAILED DESCRIPTION OF THE PREFERRED EMBODIMENT

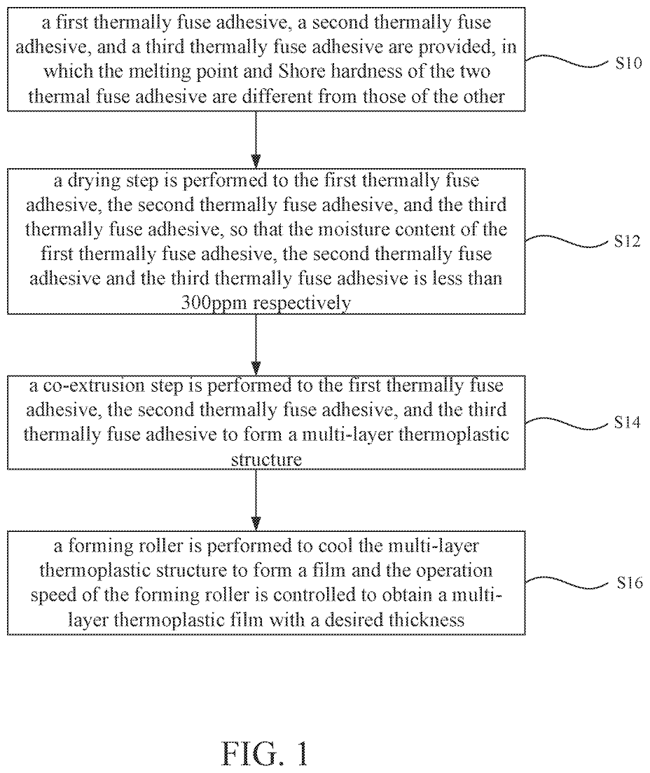

First, please refer to FIG. 1. The technology disclosed in the present invention is shown in FIG. 1 as a schematic flow chart of the manufacturing steps of the thermoplastic film, the Step S10: a first thermally fuse adhesive, a second thermally fuse adhesive, and a third thermally fuse adhesive are provided, in which the melting point and Shore hardness of the two thermal fuse adhesive are different from those of the other. In this step, the melting point of the first thermally fuse adhesive ranges from 50° C. to 120° C., the Shore hardness (Shore A) ranges from 60 A to 80 A, and the melting point of the second thermally fuse adhesive ranges from 90° C. to 160° C., the Shore hardness (Shore A) ranges from 40 A to 60 A, and the melting point and Shore hardness of the third thermally fuse adhesive are the same as those of the first thermally fuse adhesive. In one embodiment of the present invention, the first thermally fuse adhesive, the second thermally fuse adhesive, and the third thermally fuse adhesive are thermoplastic polyurethane (TPU), in which the first thermally fuse film, the second thermally fuse film, and the third thermally fuse film are thermoplastic polyurethane, and the thermoplastic polyurethane can be thermoplastic polyurethane (TPU) with aromatic functional groups or with aliphatic functional groups.

Next, step S12: a drying step is performed to the first thermally fuse adhesive, the second thermally fuse adhesive, and the third thermally fuse adhesive, so that the moisture content of the first thermally fuse adhesive, the second thermally fuse adhesive and the third thermally fuse adhesive is less than 300 ppm respectively. In this step, the first thermally fuse adhesive, the second thermally fuse adhesive, and the third thermally fuse adhesive are respectively dried at a drying temperature range from 40° C. to 70° C. The purpose of this step is to control the moisture content of the first thermally fuse adhesive, the second thermally fuse adhesive, and the third thermally fuse adhesive, so as to avoid excessively high moisture content of the thermoplastic film formed subsequently, and the peel strength of the thermoplastic film can be reduced.

Step S14: a co-extrusion step is performed to the first thermally fuse adhesive, the second thermally fuse adhesive, and the third thermally fuse adhesive to form a multi-layer thermoplastic structure. In this step, a first co-extrusion step is performed with a first extruder to the first thermally fuse adhesive to form a first thermally fuse film, a second co-extrusion step is performed with a second extruder to the second thermally fuse adhesive to form a second thermally fuse film, and a third co-extrusion step is performed with a third extruder to the third thermally fuse adhesive to form a third thermally fuse film, in which the first thermally fuse film, the second thermally fuse film and the third thermally fuse film forms a multi-layer thermoplastic structure, and the middle layer of the multi-layer thermoplastic structure is the second thermally fuse film, and the top layer and bottom layer of the multi-layer thermoplastic structure respectively are the first thermally fuse film and the third thermally fuse film, and the thickness ratio of the top layer, the middle layer and the bottom layer of the multi-layer thermoplastic structure is 1:1-2:1. In one embodiment of the present invention, the first extruder, the second extruder, and the third extruder respectively have a plurality of temperature zones. For example, the plurality of temperature zones of the first extruder, the second extruder and the third extruder includes at least three temperature sections, and the three temperature sections of the first extruder respectively are 175° C., 205° C. and 200° C. in sequence, the three temperature sections of the second extruder respectively are 155° C., 175° C. and 170° C. in sequence, and the three temperature sections of the third extruder are the same as the first extruder. In addition, the temperatures of the T-Die of the first extruder, the second extruder and the third extruder ranges from 180° C. to 190° C. respectively. In this embodiment, the preferred temperature of the T-Die of the first extruder, the second extruder and the third extruder is 185° C. It should be noted that, in this step, by adjusting the operation speed at which the first thermally fuse film, the second thermally fuse film, and the third thermally fuse film are put into the first extruder, the second extruder and the third extruder, controlling the temperature of each temperature sections, and the temperature of the T-Die are used to adjust the thickness of the multi-layer thermoplastic structure after co-extrusion.

Then, step S16: a forming roller is performed to cool the multi-layer thermoplastic structure to form a film and the operation speed of the forming roller is controlled to obtain a multi-layer thermoplastic film with a desired thickness. In this step, the multi-layer thermoplastic structure formed in the previous step is cooled to form a film through a forming roller, and an operation speed of the forming roller is controlled to be 8M/min-10M/min during the film forming process, thereby the thickness of the film is adjusted to obtain a desired thickness, in which M is expressed in meters. Finally, the film is wound up and left to stand for 1-2 working days to mature, so a multi-layer thermoplastic film can be obtained.

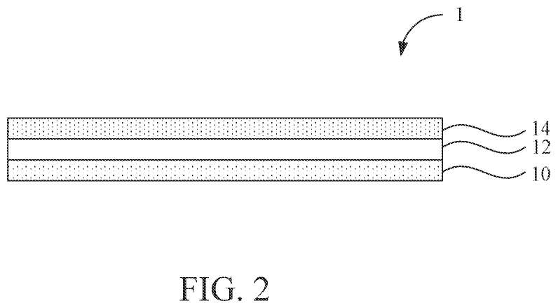

Next, please refer to FIG. 2. FIG. 2 is a schematic cross-sectional view of a multi-layer thermoplastic film formed according to the step flow of FIG. 1. The multi-layer thermoplastic film 1 in FIG. 2 is prepared according to the above steps S10 to S16, and the relevant physical properties are not repeated here. The multi-layer thermoplastic film 1 is the first thermally fuse film 10, the second thermally fuse film 12, and the third thermally fuse film 14 from bottom to top in sequence. The thickness ratio of the first thermally fuse film 10, the second thermally fuse film 12, and the third thermally fuse film 14 is 1:1-2:1. In addition, the thickness of the first thermally fuse film 10 and the third thermally fuse film 14 accounts for 40%-100% of the total thickness of the multi-layer thermoplastic film 1, and the thickness of the second thermally fuse film 12 accounts for 0%-60% of the total thickness of the multi-layer thermoplastic film 1, in which the first thermally fuse film 10, the second thermally fuse film 12, and the third thermally fuse film 14 may be thermoplastic polyurethane, and the thermoplastic polyurethane can be thermoplastic polyurethane with aromatic functional group or with aliphatic functional group. The physical properties of the multi-layer thermoplastic film 1 are listed in Table 1 herein.

TABLE 1

| Physical property | |
|---|---|
| Shore hardness (Shore A) | 40-80 |
| Tension strength (Kg_{f}/cm²) | 200-300 |
| Elongation (%) | 600-1000 |
| 300% Stress (Kg_{f}/cm²) | 20-50 |
| Elastic recovery (%) | 85-95 |

It should be noted that the physical property testing method of the above-mentioned multi-layer thermoplastic film 1 is tested by ASTM D882, and the multi-layer thermoplastic film 1 test piece of 25.4 mm*150 mm is taken, and the clamp distance is 75 mm, and the operation speed is 300 mm/min, the maximum strength force is to be taken. The above-mentioned ASTM D822 is a standard test method for physical properties of thin films well known to those skilled in the art, and the steps and procedures of the test are not described here.

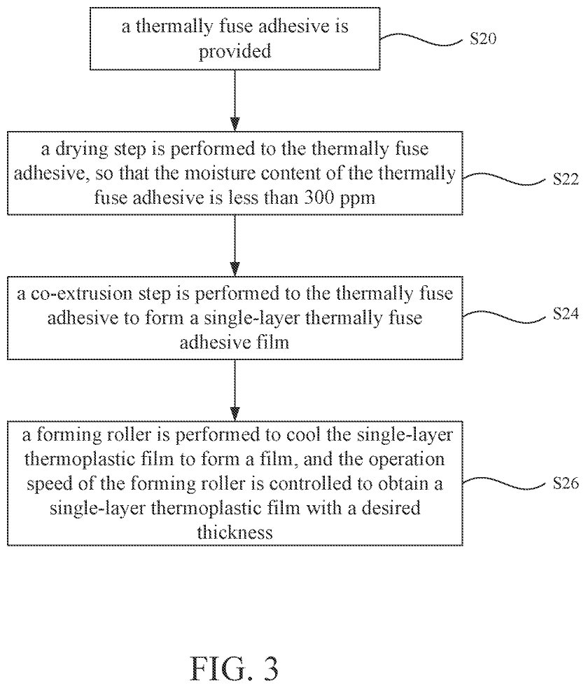

In addition, in another embodiment of the present invention, a single-layer thermoplastic film is also provided. As shown in FIG. 3. FIG. 3 is a schematic diagram showing the process steps of a single-layer thermoplastic film according to the technology disclosed in the present invention. Step S20: a thermally fuse adhesive is provided. In this step, the thermally fuse adhesive has a melting point ranges from 50° C. to 160° C., a preferable melting point may be range from 50° C. to 120° C., another preferable melting point range from 90° C. to 160° C., and the Shore hardness range for the single-layer thermally fuse adhesive ranges from 40 A to 80 A, the preferred Shore hardness ranges from 40 A to 60 A, and another preferred Shore hardness ranges from 60 A to 80 A. Next, step S22: a drying step is performed to the thermally fuse adhesive, so that the moisture content of the thermally fuse adhesive is less than 300 ppm. Similarly, the thermally fuse adhesive is dried at the same drying temperature ranges from 40° C. to 70° C. as in the previous step S12. The purpose of this step is to control the moisture content of the thermally fuse adhesive, so as to avoid excessively high moisture content subsequently formed single-layer thermoplastic film, thereby the peel strength of the thermoplastic film is to be reduced. Step S24: a co-extrusion step is performed to the thermally fuse adhesive to form a single-layer thermally fuse adhesive film. In this step, a co-extrusion step is performed with an extruder to the thermally fuse adhesive to form a thermally fuse adhesive film. As same as previously described, the extruder in this embodiment has a plurality of temperature zones, and there are at least three temperature sections. If the extruder used in step S24 is the above-mentioned first extruder, the three temperature sections are respectively 175° C., 205° C. and 200° C. in sequence. If the extruder used in step S24 is the above-mentioned second extruder, the three temperature sections are 155° C., 175° C. and 170° C. in sequence, and the temperature range of the T-Die of the extruder ranges from 180° C. to 190° C., and the preferred temperature of the T-Die of the extruder is 185° C. In this step, the thickness of the single-layer thermoplastic film after co-extrusion is also adjusted by adjusting the operation speed at which the thermally fuse adhesive is fed into the extruder, by controlling the temperature of each temperature sections of the extruder and the temperature of the T-Die. Step S26: a forming roller is performed to cool the single-layer thermoplastic film to form a film, and the operation speed of the forming roller is controlled to obtain a single-layer thermoplastic film with a desired thickness. In this step, the single-layer thermoplastic film formed in the previous steps is cooled to form a film through the forming roller, and the operation speed of the forming roller is controlled to be 8M/min-10 M/min during the film forming process, thereby, the thickness of the film is adjusted to obtain a desired thickness, in which M is expressed in meters. Finally, the film is wound up and left to stand for 1-2 working days to mature, so a single-layer thermoplastic film can be obtained.

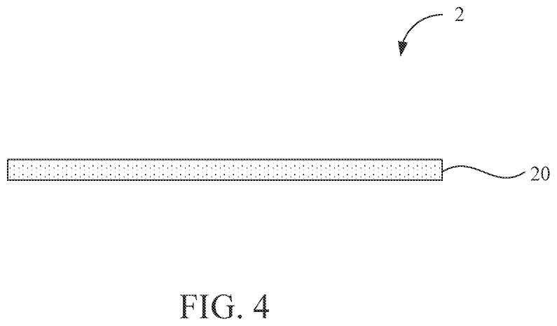

Next, please refer to FIG. 4. FIG. 4 is a schematic cross-sectional view of a single-layer thermoplastic film formed according to the step flow of FIG. 3. The single-layer thermoplastic film 2 in FIG. 4 is prepared according to the above steps S20 to S26, and the relevant physical properties are not repeated here. The single-layer thermoplastic film 2 is composed of a single-layer thermally fuse film 20, in which the thermally fuse film 20 may be thermoplastic polyurethane, and the thermoplastic polyurethane can be thermoplastic polyurethane with aromatic functional groups or with aliphatic functional groups. The physical properties of the single-layer thermoplastic film 2 are listed in Table 2 herein.

TABLE 2

| Physical property | |
|---|---|
| Shore hardness (Shore A) | 60-80 |
| Tension strength (Kg_{f}/cm²) | 200-300 |
| Elongation (%) | 400-800 |
| 300% Stress (Kg_{f}/cm²) | 30-50 |
| Elastic recovery (%) | >80 |

In the present invention, all the conditions for preparing the single-layer thermoplastic film 2 are the same as those for preparing the multi-layer thermoplastic film 1. Therefore, when testing various physical properties, the single-layer thermoplastic film 2 and the multi-layer thermoplastic film 1 can be compared.

Next, the multi-layer thermoplastic film 1 and the single-layer thermoplastic film 2 are compared with various physical properties to prove the physical performance of the multi-layer thermoplastic film 1 is improved after the structure of the multi-layer thermoplastic film 1 is changed, and the peel strength is not to be decreased due to the structure changed.

First, the peel strength of the multi-layer thermoplastic film 1 and the single-layer thermoplastic film 2 is compared, and the comparison results are shown in Table 3.

TABLE 3

| | | Tension | Elongation | 300% | Elastic | Shore |
|---|---|---|---|---|---|---|
| | | strength | rate | Stress | recovery | hardness |
| | Direction | (Kg_{f}/cm²) | (%) | (Kg_{f}/cm²) | (%) | (shore A) |
| single-layer thermo | Machine | 200-300 | 400-800 | 30-50 | >80 | 60-80 |
| plastic film | Direction (MD) | | | | | |
| | Cross | 200-300 | 400-800 | 30-50 | >80 | |
| | Direction (CD) | | | | | |
| multi-layer thermo | Machine | 200-300 | 600-1000 | 20-30 | >90 | 40-60 |
| plastic film | Direction (MD) | | | | | |
| | Cross | 200-300 | 600-1000 | 20-30 | >90 | |
| | Direction (CD) | | | | | |

It can be obtained from Table 3, that the physical properties of the multi-layer thermoplastic film 1 are changed due to the structure is changed from a single-layer to a three-layer, but the peel strength does not decrease due to the change in the structure.

Next, the multi-layer thermoplastic film 1 and the single-layer thermoplastic film 2 are subjected to unwashed and washed to compare the peel strength, as shown in Table 4 and Table 5, respectively.

TABLE 4

| | single-layer | multi-layer |
|---|---|---|
| unwashed | thermoplastic film | thermoplastic film |
| 120° C. peel strength (cN) | 4640 | 4431 |
| 130° C. peel strength (cN) | 4438 | 4231 |

TABLE 5

| | single-layer | multi-layer |
|---|---|---|
| Washed | thermoplastic film | thermoplastic film |
| 120° C. peel strength (cN) | 3091 | 2817 |
| 130° C. peel strength (cN) | 3394 | 3173 |

In can be obtained from the comparison between Table 4 and Table 5, the peel strength of the multi-layer thermoplastic film 1 is not much different from the single-layer thermoplastic film 2 with or without being washed with water. This also means that the drying step is performed in the formation process of the multi-layer thermoplastic film 1 to decrease the moisture content of the first thermally fuse adhesive, the second thermally fuse adhesive and the third thermally fuse adhesive, so the peel strength will not decrease because the structure of the thermoplastic film 1 is changed from single layer to three layers (or multiple layers) after the multi-layer thermoplastic film 1 is washed in the water washing test. In the present invention, the peel strength test method is performed by using ASTM D1876, the test pieces of 25.4 mm*300 mm is respectively taken from the multi-layer thermoplastic film 1 and the single-layer thermoplastic film 2, the distance between the clamps is 75 mm and the operation speed is 300 mm/min, the average strength force is to be taken. Here, ASTM D1876 is a standard test method for peel strength, which is a standard test method for peel strength of films well known to those skilled in the art, and the test steps and procedures are not described here.

In the present invention, the multi-layer thermoplastic film 1 and the single-layer thermoplastic film 2 are further subjected to an evaluation step. The evaluation step is to soak the multi-layer thermoplastic film 1 and the single-layer thermoplastic film 2 in the soaking solution, and the peel strength is tested by using the above-mentioned ASTM D1876 test method, and the chemical resistance is judged according to the test results of the peel strength. The evaluation steps include: a plurality of test pieces of single-layer thermoplastic film 2 and a plurality of test pieces of multi-layer thermoplastic film 1 are taken respectively, the different soaking solutions is applied on the laminating point of each single-layer thermoplastic film 2 and the permeable film respectively, and the different soaking solutions is also applied on the laminating point of the multi-layer thermoplastic film 1 and the permeable film. After standing for 24 hours, the peel strength of the soaked single-layer thermoplastic film 2 and the soaked multi-layer thermoplastic film 1 are tested respectively by ASTM D1876 test method, and the peel strength (cN) at 120° C. is the same as that in Table 4 above. Under the same conditions, the unwashed single-layer thermoplastic film 2 and the unwashed multi-layer thermoplastic film 1 are compared. The chemical resistance of the single-layer thermoplastic film 2 and the multi-layer thermoplastic film 1 is judged by the peel strength. The soaking solution used in this test is a disinfectant such as: laundry sanitizer, detergent or hand wash liquid, safflower oil, methyl salicylate, bleach, acid solution with pH value of 5.5 and alkaline solution with pH value of 8, the test results of its chemical resistance are shown in Table 6.

TABLE 6

| | single-layer | multi-layer |
|---|---|---|
| | thermoplastic film | thermoplastic film |
| chemical resistance | (cN) | (cN) |
| disinfectant | 4116 | 4144 |
| methyl salicylate | 3904 | 2684 |
| safflower oil | 1665 | 1610 |
| bleach | 4113 | 3944 |
| acid solution (pH = 5.5) | 3426 | 3272 |
| alkaline solution (pH = 8) | 3426 | 3589 |

From the test results in Table 6, compared with the test results of unwashed single-layer thermoplastic film 2 and the unwashed multi-layer thermoplastic film 1 in Table 4, The chemical resistance of the multi-layer thermoplastic film 1 after soaking in the soaking solution is not much different from the chemical resistance of the single-layer thermoplastic film 2, and the first thermally fuse film 10 of the first layer and the third thermally fuse film 14 of the third layer of the multi-layer thermoplastic film 1 has chemical resistance and the second thermally fuse film 12 of the second layer (middle layer) provides corresponding physical properties, thereby enhancing the chemical resistance of the multi-layer thermoplastic film 1 to chemical substances.

According to the above, either the single-layer thermoplastic film 2 or the structurally modified multi-layer thermoplastic film 1, all have chemical resistance, and the peel strength will not be reduced by changing from a single-layer to a multi-layer, therefore, either the single-layer thermoplastic film 2 or the multi-layer thermoplastic film 1 can both be widely used in undergarment to increase the service life of the undergarment.

What is claimed is:

1. A thermoplastic film, composed of a single-layer of a thermally fuse film, a melting point of the single-layer of the thermally fuse film ranges from 50° C. to 160° C. and a Shore hardness ranges from 40 A to 80 A, wherein the thermally fuse film is thermoplastic polyurethane, and the thermoplastic polyurethane may be thermoplastic polyurethane with aromatic functional group or with aliphatic functional group.

2. The thermoplastic film of claim 1, wherein the single-layer of the thermally fuse film is formed by an extruder with a co-extrusion step to a thermally fuse adhesive with a melting point range from 50° C. 160° C. and a Shore hardness ranges from 40 A to 80 A.

3. The thermoplastic film of claim 2, wherein the single-layer thermally fuse film is cooled to form a film by a forming roller.

4. The thermoplastic film of claim 3, wherein the single-layer of the thermoplastic film with a desired thickness is controlled by an operation speed of a forming roller.

5. The thermoplastic film of claim 2, wherein a moisture content of the thermally fuse film is less than 300 ppm.

6. The thermoplastic film of claim 5, wherein the moisture content of thermally fuse film is dried by a drying step with a drying temperature ranges from 40° C. to 70° C.

7. The thermoplastic film of claim 2, wherein the extruder includes a plurality of temperature zones, and the plurality of temperature zones includes at least three temperature sections, each of the temperature section ranges in 175° C., 205° C. and 200° C. or 155° C., 175° C. and 170° C.

8. The thermoplastic film of claim 2, wherein a temperatures of a T-Die of the extruder ranges from 180° C. to 190° C.

9. A thermoplastic film, composed of a multiple layer structure, from bottom to top comprising a first thermally fuse film, a second thermally fuse film and a third thermally fuse film, a thickness ratio of the first thermally fuse film, the second thermally fuse film and the third thermally fuse film is 1:1˜1:2, wherein the first thermally fuse film, the second thermally fuse film and the third thermally fuse film are thermoplastic polyurethane, and the thermoplastic polyurethane may be thermoplastic polyurethane with aromatic functional group or with aliphatic functional group.

10. The thermoplastic film of claim 9, wherein a melting point of the first thermally fuse film and the third thermally fuse film ranges from 50° C. to 120° C., and a Shore hardness ranges of the first thermally fuse film and the third thermally fuse film ranges from 60 A to 80 A, the melting point of the second thermally fuse film ranges from 90° C. to 160° C., and a Shore hardness of the second thermally fuse film ranges from 40 A to 60 A.

11. The thermoplastic film of claim 9, wherein a thickness of the first thermally fuse film and the third thermally fuse film accounts for 40%-100% of a total thickness of the thermoplastic film, and a thickness of the second thermally fuse film accounts for 0%-60% of a total thickness of the thermoplastic film.

12. A method for manufacturing a composite thermoplastic film, comprising:
providing a first thermally fuse adhesive, a second thermally fuse adhesive and a third thermally fuse adhesive, a melting point and a Shore hardness of the two are different from those of the other;
performing a co-extrusion step to form a multi-layer thermoplastic structure, and the co-extrusion step comprising:
performing a first co-extrusion step with a first extruder to the first thermally fuse adhesive to form a first thermally fuse film;
performing a second co-extrusion step with a second extruder to the second thermally fuse adhesive to form a second thermally fuse film; and
performing a third co-extrusion step with a third extruder to the third thermally fuse adhesive to form a third thermally fuse film,
wherein the first thermally fuse film, the second thermally fuse film and the third thermally fuse film forms the multi-layer thermoplastic structure, a middle layer of the multi-layer thermoplastic structure is the second thermally fuse film, a top layer and a bottom layer of the multi-layer thermoplastic structure is the first thermally fuse film and the third thermally fuse film, and a thickness ratio of the top layer, the middle layer, and the bottom layer of the multi-layer thermoplastic structure ranges from 1:1 to 2:1; and
performing a film forming step, a forming roller is performed to cool the multi-layer thermoplastic structure into a film and an operation speed of the forming roller is controlled to obtain a multi-layer thermoplastic film with a desired thickness.

13. The method of claim 12, further comprising performing a drying step before performing the co-extrusion step, wherein the first thermally fuse adhesive, the second thermally fuse adhesive and the third thermally fuse adhesive are dried at a drying temperature that ranges from 40° C. to 70° C., thereby a moisture content of the first thermally fuse adhesive, the second thermally fuse adhesive, and the third thermally fuse adhesive are less than 300 ppm respectively.

14. The method of claim 12, wherein the first extruder, the second extruder and the third extruder respectively have a plurality of temperature zones, and the temperature zones of the first extruder and the third extruder includes at least three temperature sections, the three temperature sections are 175° C., 205° C., and 200° C. in sequence, and the temperature zones of the second extruder includes at least three temperature sections, the three temperature sections are 155° C., 175° C., and 170° C. in sequence.

15. The method of claim 12, wherein the temperature zone of a T-Die of the first extruder, the second extruder, and the third extruder ranges from 180° C.-190° C.
